(19) United States
(12) Patent Application Publication
(10) Pub. No.: US 2014/0224183 A1
(43) Pub. Date: Aug. 14, 2014

(54) Interactive Ball Rebounding Toy for Pets

(71) Applicant: Sheri Bock, Sacramento, CA (US)

(72) Inventor: Sheri Bock, Sacramento, CA (US)

(21) Appl. No.: 14/178,326

(22) Filed: Feb. 12, 2014

Related U.S. Application Data
(60) Provisional application No. 61/764,021, filed on Feb. 13, 2013.

(51) Int. Cl. A01K 15/02

(52) U.S. Cl. CPC A01K 15/025
USPC 119/707

(57) ABSTRACT

The present invention provides a pet operated ball rebounding toy that is adapted to rebound a rolled ball back to the approximate origin of the rolled ball upon contact. The present invention comprises a housing having at least one exterior surface. At least one ball rebounding target is disposed on one of the housing exterior surfaces, while the housing further comprises a power supply means, a motion sensor, a target impact sensor, and optional hinges that are adapted for securing together adjacent housings. The interior of the housing comprises a control circuit that controls a solenoid, a plunger, and a speaker. In use, a pet pushes a ball towards the target, thereafter the motion sensor detects the ball motion or an impact sensor recognizes a contact between the ball and the target such that the control circuit instructs a solenoid plunger to thrust outward, thereby contacting and rebounding the ball.

### CROSS REFERENCE TO RELATED APPLICATION

This application claims the benefit of U.S. Provisional Application No. 61/764,534 filed on Feb. 13, 2013, entitled “Spring Loaded Bowling for Dogs” The above identified patent application is herein incorporated by reference in its entirety to provide continuity of disclosure.

### BACKGROUND OF THE INVENTION

1. Field of the Invention

The present invention relates to an interactive pet toy. More specifically the invention relates to a ball toy comprising a target that when hit by a ball, rebounds the ball back in the general direction of the pet, thereby providing exercise and entertainment for the pet.

It is known that pets, especially dogs, require exercise to remain healthy, happy, and in shape. And even though different breeds of dogs demand different amounts of exercise and interaction from their owners, the majority of exercise occurs through a few different ways. One means of exercise involves going on walks. These walks can lead to a trip to a dog park where the pet can roam freely and play with other pets. Another form of exercise involves playing with the pet owner. This can involve general horse play, a friendly run, or a game of fetch in which the owner the owner throws the ball and the dog retrieves the ball for another throw.

Playing the game of fetch is the most desirable form of interaction between a pet and an owner. The game provides enjoyment and exercise for the pet, while bringing the pet and owner closer together. The acts of retrieving the ball, returning it, and subsequently chasing after the ball once again can provide a sufficient amount of exercise for the pet, and depending on the size of the dog and the size of the house the game can be played indoors or outdoors and may provide hours of fun.

While the game of fetch is capable of providing exercise and enjoyment for a dog, there may be times when the owner might be away from the dog or may not be capable of playing. During these times the dog may become bored and may be left without an opportunity to sufficiently exercise, which can lead to an unhappy, unhealthy, or an out of shape pet. As such, there is a desire for a means to allow a pet to play a game of fetch without requiring the participation of a pet owner, thereby enabling the pet to exercise when alone.

The present invention, however, presents an interactive toy that provides a means for a pet to play fetch without requiring the participation of a pet owner. The device of the present invention comprises a box-shaped housing with a target thereon. When a pet rolls or otherwise pushes a ball towards the target, the a solenoid within the housing and behind the target contacts the ball and forces it away from the housing, similar to the action of pinball machine bumpers. The device of the present invention, therefore, enables a pet to play fetch independently or otherwise entertain themselves. Moreover, the device of the present invention comprises a speaker that can provide encouraging phrases for the pet after a successful session of fetch, thereby providing enjoyment and comfort to the pet while facilitating exercise.

2. Description of the Prior Art

Devices have been disclosed in the prior art that relate to interactive dog toys. These include devices that have been patented and published in patent application publications. These devices, however, generally relate to dog toys that require the dog to place a ball within a device prior to the ball being projected outward. The following is a list of devices deemed most relevant to the present disclosure, which are herein described for the purposes of highlighting and differentiating the unique aspects of the present invention, and further highlighting the drawbacks existing in the prior art.

One such prior art device, U.S. Pat. No. 6,176,230 to Thompson provides a portable projectile launcher for a pet, whereby the launcher individually sends out a plurality of projectiles. The device comprises a base, a receptacle, and a feeder that extends from the interior of the receptacle to the front of the base. The device is sized for use by a pet. Housed within the base is a launching mechanism that is adapted for striking a baseball sized ball that is located within a slot of the base after being gravity fed through the feeder, thereby launching the ball for the amusement of the pet. The prior art comprises a striking mechanism to launch the ball, however, the prior art striking mechanism lacks the ability to return a rolled ball, similar to that as provided by the present invention.

Another prior art device, U.S. Pat. No. 4,995,374 to Black provides a dog toy that is adapted for launching a ball after the ball is placed into the collection area by the dog. A sensor detects the ball within the device and sends a command signal to a solenoid plunger to impact a ball that lies in a resting position. Thereafter the ball is launched through the hollow interior of the device and is sent on an airborne trajectory out of the device. Although the solenoid of Black is similar in nature and relevant to the present invention, it differs in that it fails to rebound a tossed ball by a pet.

U.S. Pat. No. 7,114,465 to Winter provides a pet operated ball thrower. The ball thrower comprises a base, an actuator attached to the base, a post attached at its lower end to the base, and a throwing arm that is pivotally attached to the post. A receiving receptacle is attached to the throwing arm and is sized to receive a ball therein. In use, a pet is trained to place a ball within the receptacle of the throwing arm. Thereafter, the pet jumps or steps on the actuator, thereby rotating the throwing arm, which sends the ball in the air for retrieval by the pet. This sequence may be repeated by the pet in order to facilitate play and exercise. The prior art device, while similar in nature and relevant to the present invention, fails to provide a pet operated toy that involves a means for rebounding a tossed ball back towards the general direction of the pet, thereby amusing the pet.

Alternatively, prior art device, U.S. Pat. No. 4,078,806 to Brandell provides a golf putting practice device that comprises a kicker for returning a ball to a person after making a putt into the device. The device comprises an abutment member on the inner wall of the device for abuttingly engaging the kicker, thereby determining the return force of the ball back towards the individual. Further, the kicker unit comprises a solenoid that delivers the force that sends the ball back towards the direction of the golfer. The prior art device, however, fails to provide an immediate rebounding device, and further fails to provide encouragement for successful use of the device.

Finally, U.S. Pat. No. 6,623,371 to Corcoran provides a golf putting and ball return system. The device of the putting and ball return system is adapted to control the motion of the ball within the device by slowing the momentum of the ball and then allowing the golf ball to move under the influence of gravity. As such, the ball approaches the kicker unit along a controlled path, thereby providing for the consistent placement in front of the kicker unit and further provides for a consistent return of the golf ball. However, while prior art device provides a ball return means similar to that of the present invention, it differs in that the present invention provides inconsistent returns of the ball, which increases the enjoyment of the device for a pet.

While the prior art devices all provide a means for sending a ball towards the direction of an individual or pet, they each differ from the present invention in terms of purpose, means, or direction. The present invention provides a means for a pet to play an interactive game without requiring the involvement of a pet owner. The present invention comprises a housing having an exterior surface with a target thereon that is adapted for returning a rolled ball when the ball strikes the target or is in the vicinity thereof. The housing interior comprises a control circuit that instructs a solenoid to make contact with the incoming ball, thereby projecting the target surface away from the ho using in order to contact and return the ball.

The present invention further comprises a means for detecting the presence of a ball in the vicinity of the target surface prior to contact therewith, thereby efficiently enabling an activation of the solenoid to return the ball to the pet. In use, a trained pet pushes the ball towards one or more targets, thereafter, the motion sensor detects the presence of the ball near the target surface and activates the solenoid plunger for projecting the target surface outward from the housing to contact the rolled ball and send it in the opposite or tangential direction. The solenoid extends through the target surface or projects the entire target surface outward from the housing, thereby accelerating the ball back toward the relative area of the pet or in a tangential direction therefrom.

In view of the drawbacks of the prior art devices, is it submitted that the present invention is substantially divergent in design elements from the prior art, and subsequently it is clear that there is a need in the art for an improvement to existing pet ball rebounding devices. In this regard the instant invention substantially fulfills these needs.

### SUMMARY OF THE INVENTION

In view of the foregoing disadvantages inherent in the known types of pet toys now present in the prior art, the present invention provides a new ball return pet toy that can be utilized for providing convenience for the user when enabling a pet to play fetch independently of the pet owner.

It is therefore an object of the present invention to provide a new and improved ball return pet toy device that has all of the advantages of the prior art and none of the disadvantages.

It is another object of the present invention to provide a ball return pet toy device that is interactive with the pet and enables use thereof without the assistance of the pet owner.

Another object of the present invention is to provide a ball return pet toy device that rebounds a rolled ball back in the general direction thereof or in a tangential direction when contact is made with a target surface.

Yet another object of the present invention is to provide a ball return pet toy device that provides encouraging messages when a successful act has occurred.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 displays the exemplary embodiment of the present invention.

FIG. 2 displays a view of an alternate configuration of the housing of the of the present invention, wherein the housing is curved and provides a plurality of target surfaces thereon.

FIG. 3 displays a view of the exemplary embodiment of the present invention and its working components.

FIG. 4 displays a view of the ball return solenoid and the target surface of the present invention.

FIG. 5 displays a view of an embodiment of the present invention in use with a pet dog, wherein three housings and three targets are provided for increased target area.

FIG. 6 displays a view of the present invention in use, whereby the ball is being returned in the direction of the dog and the speaker projects a sound upon action of the solenoid.

### DETAILED DESCRIPTION OF THE INVENTION

Reference is made herein to the attached drawings. Like reference numerals are used throughout the drawings to depict like or similar elements of the ball return pet toy device of the present invention. For the purposes of presenting a brief and clear description of the present invention, the preferred embodiment will be discussed as used for providing enjoyment for a pet without requiring the assistance of a pet owning individual. The figures are intended for representative purposes only and should not be considered to be limiting in any respect.

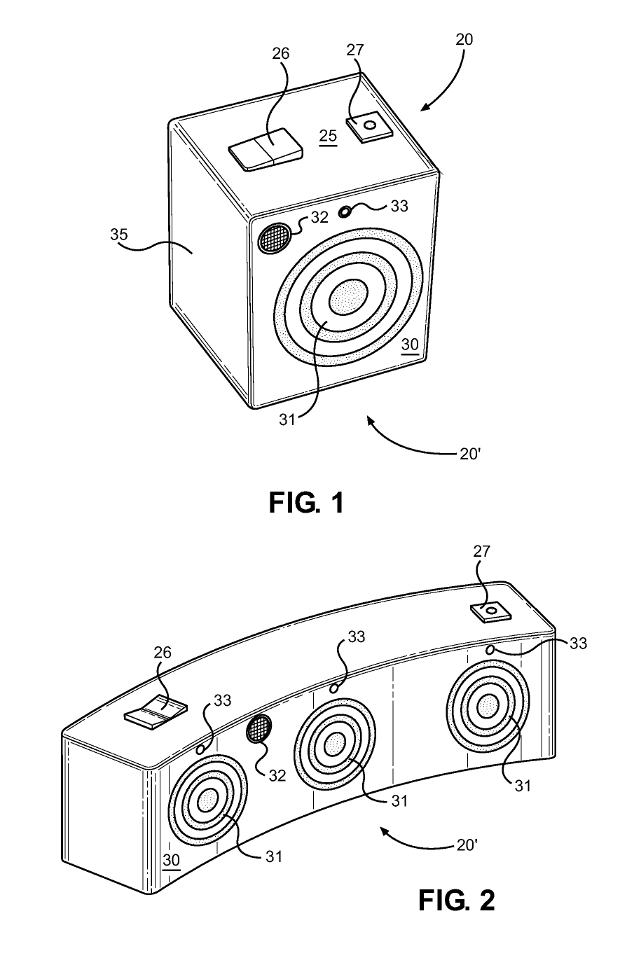

Referring now to FIG. 1, there is displayed a view of the exemplary embodiment of present invention. The device comprises an assembly that supports an internal mechanism for returning a ball that is rolled thereagainst, whereby the ball is impacted by a solenoid and accelerated away therefrom. In this way, the device comprises a play toy for pets, wherein the pet can amuse itself without attention by the pet owner. The device comprises a main housing 20 that is preferably box-shaped and includes upper 25, base, side 35, and front surfaces 30. The front surface 30 of the housing 20 comprises a ball proximity detection means, a speaker 32, and a target surface 31. The target surface 31 comprises an area in which the pet can direct the ball and from which the plunger of a solenoid with project. The ball is thereby projected outward from the target surface 31 when impacted by a force from the solenoid within the housing 20.

The solenoid and the ball proximity detection means on the front surface are operatively connected to a control circuit within the housing 20 to facilitate operation. In a preferred embodiment, the ball proximity detection means is a motion detector 33, which is utilized for detecting a ball within the proximity of the target surface 31 and provides a signal that instructs the striking end of the solenoid to activate for striking the ball to change its course. An alternate embodiment of the ball proximity detection means contemplates an impact sensor along the front surface 30 of the housing 20 such that impacts from a rolled ball are registered and used to initiate the ball return solenoid.

The front surface 20 further comprises a microphone and speaker 32 that is adapted for delivering audio to the pet after a successfully delivered ball. These phrases can vary in length and may be randomly delivered or delivered in the order when they were recorded. The phrases may be recorded by depressing the recording button 27 on the upper surface 25 of the housing exterior and speaking into a microphone provided thereon. The control circuit, which comprises a processing means, memory, storage, and connection to a power source, is used to both control operation of the ball return mechanisms, but also for interacting with the microphone and speaker 32 and for storing recorded messages. The target area 31 and speaker 32 are operatively connected with control circuit within the housing to enable a phrase to be played when contact is made with the target area 31, thereby encouraging the pet to repeat the action and to provide comfort to the pet by hearing a familiar voice (e.g. the owner's voice). Alternatively, the device may be supplied with prerecorded messages to be played after contact between a ball 70 and the target area 31, wherein the microphone and recording button 27 are not provided for simplicity in design.

Preferably the power activation button 26 and the audio recording button 27 are located on the upper surface 25 of the housing 20. The power button 26 may be a toggle type on/off switch or a push button actuated switch that that enables power to be sent from the battery power source to the control circuit, and therefore facilitate operation of the device. The optional audio recording button 27 records a short phrase or message when the button is depressed by an individual. The recorded message is repeated back to the pet when the ball is successfully delivered to the designated target area of the housing, thereby providing encouragement and comfort to the pet when the owner is away or unable to play with the pet.

Referring now to FIG. 2, there is shown an alternate embodiment of the present invention, wherein the housing 20′ is provided in an elongated and curved form. It is contemplated that the housing of the present invention may take on several forms and shapes, and further may support one or more target surfaces 31 and complementary ball return mechanisms (e.g. internal solenoids and control circuits, etc.). In this embodiment, the housing is a curved structure with an elongated front surface 30, a plurality of target surfaces 31, a microphone/speaker 32, and a motion sensor 33 for each target surface 31. More than one target surfaces 31 provides an increased overall chance of success for a pet to impact the housing 20′ in a location in which will result in a returned ball, while the curved shape allows the pet to be returned a ball if the ball is not directed to the centermost target.

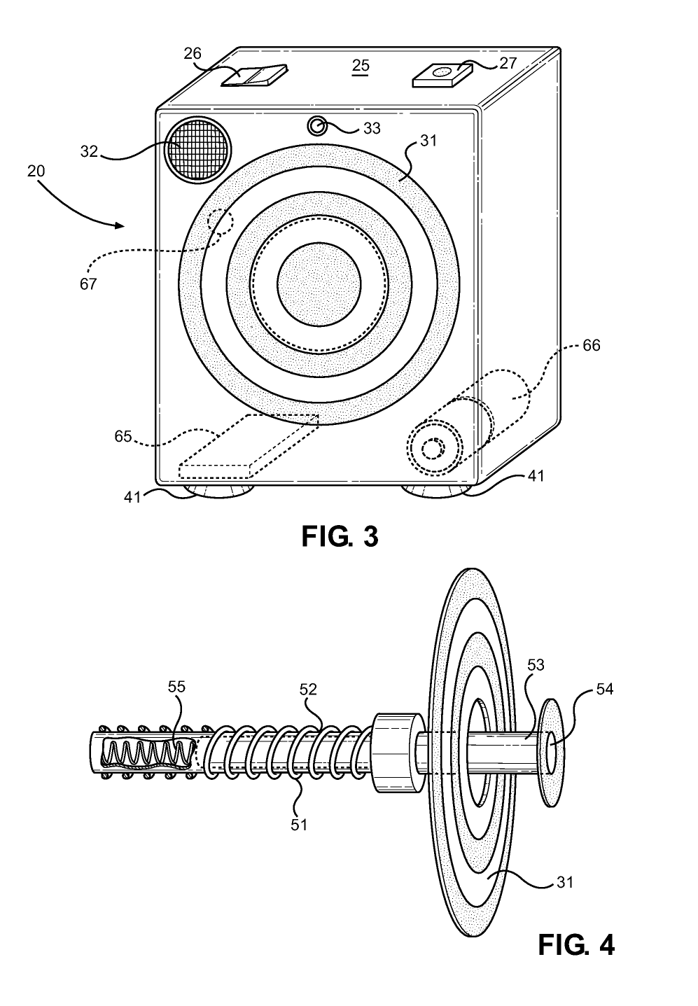

Referring now to FIG. 3, there is displayed a view of the preferred embodiment of the present invention with broken line representations of the control circuit and power source therein. The interior of the housing 20 is an open volume supporting the solenoid and the operational elements of the present invention. These include a control circuit 65, a ball return solenoid, a battery power source 66, and either a motion sensor 33 or a target impact sensor 67 along the front surface of the housing 20. The control circuit 65 commands the working elements of the device and is operatively connected to the battery 66, power switch 26, audio recording button 27, target impact sensor 67 or motion detecting sensor 33, microphone/speaker 32, and the ball return solenoid.

The control circuit comprises a processing means, and optional memory and/or storage for storage of recordings thereon. The processing means itself may be an analog circuit or microprocessor, depending on the complexity of the assembly and whether the assembly is deployed with ability to record sounds and play back the same. The control circuit 65 performs many tasks. For the battery 66, the control circuit 65 is configured for regulating the voltage that is delivered to the device through the battery 66. Furthermore, the control circuit 65 controls the voltage delivered to the battery 66 from an outlet or other source (if wall power is accommodated and a transformer is provided) in order to prevent over charging the battery by stopping the process when the charging process is complete. For the microphone/speaker 32 and recording button 27, the control circuit 65 is adapted to enable the recording of the short messages, storage of the messages, selection of which messages to play, and for playing the chosen message through the speaker 32. The control circuit 65 also monitors the impact sensor 67 and/or motion detectors 33. The control circuit 65 receives signals from the motion detector 33 to recognize an object in the proximity of the target area, or alternative the control circuit receives signals from the impact sensor when a threshold change in momentum is registered in the housing. The control circuit 65 instructs the ball return solenoid 50 activate, thereby causing the iron plunger therein to translate and thereby impact the incoming ball.

The base of the present housing 20 may include a means for attaching the device onto the floor in a sturdy manner or otherwise preventing sliding therealong. As shown in FIG. 3, the base 40 may include a pair of suction cups 41 that enable the device to be secured onto non-carpeted floors. However, when not needed, the suction cups 41 may be removed during use on cushioned floors. In carpeted areas the device may easily be placed in a corner or against a wall in order to prevent the device from tipping during use. Further, the enlarged width of the sides 35 and base 40 of the housings provides sufficient stability that prevents the toy from falling over during use. Alternatively, the base 40 may comprise a high friction material that is adapted to grip or reduce movement on a floor when the toy is in use.

Referring now to FIG. 4, there is displayed a view of the ball return solenoid of the present invention and its functional elements. The solenoid comprises a tightly wound coil 51 about an insulated hollow sleeve 52, an iron plunger 53 within the hollow sleeve 52, a striking segment 54, and a solenoid plunger return mechanism attached to the iron plunger to return the same after activation. The solenoid plunger return mechanism may comprise a return spring 55 or other suitable solenoid plunger return means known in the art of solenoids. It is submitted that this solenoid configuration is well known in the art and obvious variations thereto are contemplated, falling within the scope of providing an electronically-activated ball return means that uses a plunger or similar moving member to contact and return an incoming ball.

The ball return solenoid 50 is designed to convert electromagnetic energy into a linear motion. When power is supplied from the battery 66 to the solenoid 50, the solenoid coil quickly becomes energized. The electromagnetic field created in the coil 51 acts on the iron plunger 53 within a sleeve 52 that is surrounded by the wound coil 51. The energized coil 51 quickly draws the iron plunger 53 through the sleeve, thereby converting the electromagnetic energy into linear motion and bringing the striking segment 54 against the target area 31. The plunger 53 is biased away from the target area 31 by a return spring 55 during inactivity, and when the device is activated the target striking solenoid 50 must overcome the force of the return spring 65 in order to make contact with the target area 31. When the power is cut to the solenoid 50 the spring 55 returns the iron plunger 53 back to its resting position in preparation for another strike against the target area 31.

The act of energizing the wound coil is started by the motion detector 33 or impact sensor 67, and via the housing control circuit 65. The sensors 33, 67 are capable of communicating with the control circuit 65, whereby each supply information that influences whether or not the control circuitry 65 sends a signal to the battery 66 to energize the coil 51 cause the plunger 53 to strike the target 31. The circuitry 65 may be configured to provide a charging energy when an approaching object is detected, when an impact is detected, or when an object is seen and contacts the target, thereby preventing the target from being struck when the device is knocked down from behind or makes contact with the ground.

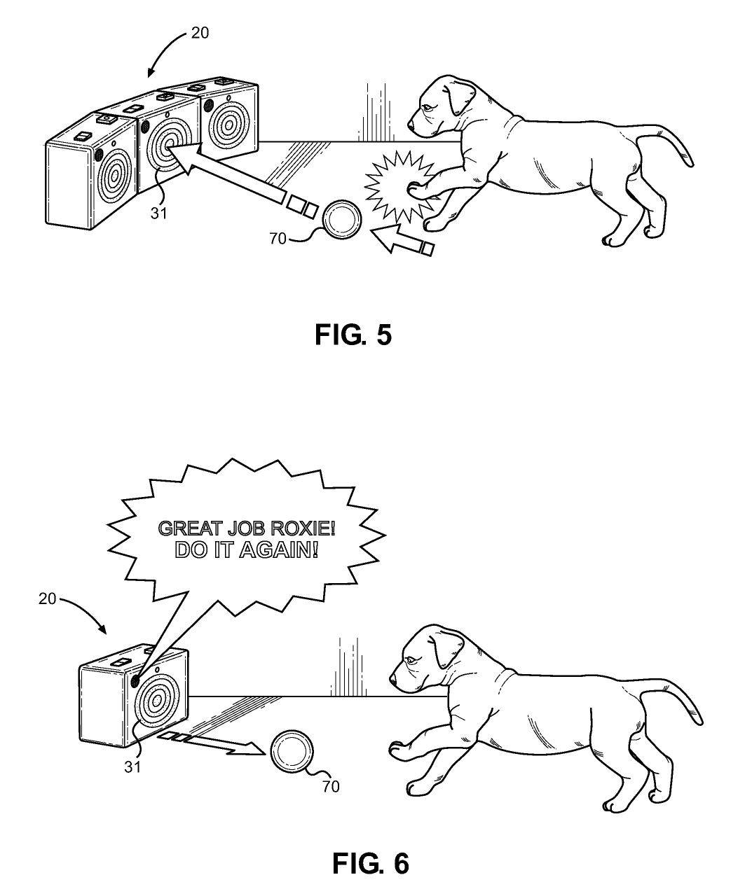

Referring now to FIG. 5, there is shown a view of the present invention in use, wherein a plurality of housings 20 are deployed to increase the overall target surface 31 area. The present invention provides an interactive pet toy that does not require the input of an owner for use. The device is adapted to provide a means for the pet to play fetch by themselves. In use, a trained pet may send a ball 70 towards one of the many target areas of the device. Once the ball 70 comes into contact with a target surface 31 on the front surface of the device, the ball return solenoid pushes back against the ball and sends it in the opposing or tangential direction. The pet may then retrieve the ball and repeat the step of sending the ball into the designated area, thereby enabling the pet to play without the input of the pet owner.

It is contemplated that the housing of the present invention may further comprises removable attachments along the sides thereof such that several housings can be connected and aligned to increase the target surface area. Each of the side housings can be operatively connected to make up for inaccuracies of a rolled ball. Furthermore, the use of multiple housings enables the device to be used efficiently in a corner, can provide angled returns depending on the direction of contact with the impact area, and provides increased stability over the use of a single housing. The attachment mechanism for securing the housings together may include a number of removably connectable fasteners, joints, or hinges to facilitate the connection thereof. Overall, it is contemplated that each housing may act independently or in a group, wherein each housing includes its own operational elements.

Referring now to FIG. 6, there is displayed a view of the present invention in use, whereby the recorded or pre-recorded message is being activated after a successful roll. The ball return solenoid is designed to immediately return a rolled ball 70 back towards the general origin of the ball path. Once the impact occurs, the stored message is played back from the speaker and to the pet for a successful playing session. The message can be one that is provided by a pet owner, thereby providing encouragement and comfort for the pet when the owner is not present or is unable to play fetch or a similar game. Because of the shape of the housing, and due to the angle that the ball impacts the target area, the ball may be returned in different directions. This greatly adds to the enjoyment of the device by having the dog chase the ball in different directions after being impacted by the target striking device.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A ball return device adapted for use by a pet, comprising:
a housing comprising a front surface, an upper surface, a base, and side surfaces defining a housing interior;
said front surface comprising a target surface;
at least one a ball return solenoid disposed within said housing interior and comprising a movable solenoid plunger;
at least one a control circuit, a power source, and at least one ball proximity detection means;
said ball return solenoid and said ball proximity detection means being electrically connected to said control circuit;
said solenoid adapted to activate when said ball proximity detection means registers a ball in proximity to said target surface;
said solenoid plunger adapted to extend said target surface outward from said front surface when said solenoid is activated to impact said ball;
said solenoid further comprises a solenoid plunger return mechanism to return said solenoid after activation.

2. The ball return device of claim 1, wherein said ball proximity detection means further comprises a motion sensor disposed on said front surface.

3. The ball return device of claim 1, wherein said ball proximity detection means further comprises an impact sensor making contact with said target surface.

4. The ball return device of claim 1, further comprising:
a storage for storing voice recordings;
a speaker for emitting said voice recordings when said solenoid is activated.

5. The ball return device of claim 1, further comprising:
a storage for storing voice recordings;
a microphone;
an audio recording button for activating said microphone and for recording voice recordings;
a speaker for playing said voice recordings when said solenoid is activated.

7. The ball return device of claim 1, wherein:
said front surface comprises an elongated and curved surface having a plurality of target surfaces thereon, each target surface having a ball return solenoid, a ball proximity detection means.

8. The ball return device of claim 1, whereby said base further comprises at least one suction cup thereon.

9. The ball return device of claim 1, whereby said base further comprises a high friction material thereon.
